(19) United States
(12) Patent Application Publication
(10) Pub. No.: US 2016/0096507 A1
(43) Pub. Date: Apr. 7, 2016

(54) THEFT PROTECTION SYSTEM

(71) Applicant: YAZAKI CORPORATION, Tokyo (JP)

(72) Inventors: Taku Furuta, Aichi (JP); Masahiro Takamatsu, Shizuoka (JP); Eiji Shimochi, Shizuoka (JP)

(21) Appl. No.: 14/966,225

(22) Filed: Dec. 11, 2015

Related U.S. Application Data
(63) Continuation of application No. PCT/JP2014/068016, filed on Jul. 7, 2014.

(30) Foreign Application Priority Data
Jul. 9, 2013 (JP) 2013-143553

(51) Int. Cl. B60R 25/102; B60R 25/10

(52) U.S. Cl. CPC B60R 25/102; B60R 25/1018; B60R 2025/1016

(57) ABSTRACT

A theft protection system for an electrical component mounted on a vehicle has an electronic device attached to a case housing the electrical component, a theft detection unit for detecting that connection of the electronic device is disconnected, and a notification for notifying a detection result by the theft detection unit. When theft detection unit detects that connection of the electronic device is disconnected, a result of the detection is notified by notification unit.

### TECHNICAL FIELD

The present invention relates to a theft protection system, and particularly relates to the theft protection system that prevents theft of an electrical component mounted on a vehicle.

### BACKGROUND ART

There is a known vehicle communication ECU provided with a theft preventing function (refer to Patent Literature 1, for example). Since the vehicle communication ECU in the related arts as a product constituting a car navigation unit disclosed in Patent Literature 1 (hereinafter, referred to as communication ECU) is used integrally with a car navigation system, the communication ECU may be a target of theft together with the car navigation system. When abnormal removal of the communication ECU is detected in a state that the communication ECU is connected to the car navigation system and attached to the vehicle (namely, at the time of detecting theft), such theft is notified to a control center and the car navigation system, and further the theft of the communication ECU is notified by displaying occurrence of the theft on a display unit of the car navigation system.

Further, Patent Literature 2 discloses a vehicle security system, in which theft of an on-vehicle article to be a monitoring object is alarmed by a horn sound. The vehicle security system issues the alarm of the horn sound at the time of detecting that a position of the on-vehicle article that is the monitoring object is moved from a proper installation position inside the vehicle interior and not installed at the proper position (namely, at the time of detecting theft).

### CITATION LIST

### Patent Literatures

Patent Literature 1: JP 2004-355241 A

Patent Literature 2: JP 2009-265887 A

### SUMMARY OF INVENTION

### Technical Problem

However, according to the inventions disclosed in Patent Literatures 1 and 2, theft is respectively detected and notified with the alarm and the like by detecting that the on-vehicle article that is the monitoring object is removed or that the on-vehicle article is moved. Therefore, since the on-vehicle article is already removed when the alarm is issued, the on-vehicle article is carried away without any hesitation. Therefore, a technology to catch a sign of the theft of the on-vehicle article by the thief and warn the thief before the on-vehicle article is carried away is demanded.

The present invention is directed to providing a theft protection system that improves a theft preventing effect relative to an electrical component mounted on a vehicle.

### Solution to Problem

The present invention is a theft protection system for an electrical component mounted on a vehicle, including: an electronic device attached to a case housing the electrical component; theft detection unit to detect that connection of the electronic device is disconnected; and notification unit to notify a detection result by the theft detection unit.

The theft protection system of the present invention further includes a display device mounted on the vehicle in the present invention, and the notification unit displays a detection result by the theft detection unit on the display device.

In the present invention, the theft detection unit is disposed at the connector and the notification unit is disposed at the junction box in the present invention.

### Advantageous Effects of Invention

According to the present invention, the detection result of a fact that connection of the electronic device attached to the case housing the electrical component is disconnected is notified by the notification unit. More specifically, the fact that connection of the electronic device is disconnected is detected before the electrical component is removed, and a notification can be given to a thief, for example, thereby improving a theft preventing effect relative to the electrical component mounted on the vehicle.

According to the present invention, the detection result by the theft detection unit is displayed on the display device mounted on the vehicle. More specifically, the warning can be more surely given to the thief by displaying a display result on the display device, and theft of the electrical component mounted on the vehicle can be more surely prevented.

According to the present invention, the theft detection unit is disposed at the connector and the notification unit is disposed at the junction box, thereby a theft protection system that issues a notification before the removal of the electrical component can be implemented.

### BRIEF DESCRIPTION OF DRAWINGS

FIG. 1 is a block diagram illustrating an embodiment of a vehicle electrical system including a theft protection system according to the present invention.

FIG. 2 is a front view of a meter mounted on an instrument panel.

FIG. 3 is a diagram schematically illustrating a center area of the instrument panel of the vehicle.

FIG. 4 is a diagram illustrating an exemplary display on a meter DISP illustrated in FIG. 1.

FIG. 5 is an explanatory diagram to describe operation of the vehicle electrical system illustrated in FIG. 1.

### DESCRIPTION OF EMBODIMENTS

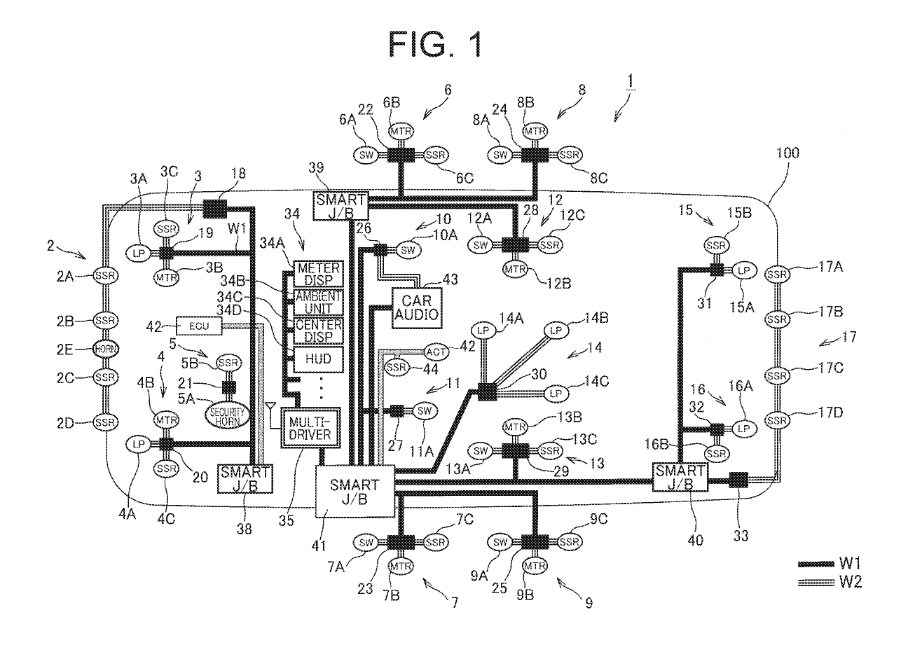

In the following, a theft protection system according to an embodiment of the present invention will be described with reference to FIGS. 1 to 5.

FIG. 1 is a block diagram illustrating an embodiment of a vehicle electrical system including a theft protection system according to the present invention. As illustrated in the drawing, a vehicle electrical system 1 includes modules 2 to 17 disposed in respective portions of a vehicle 100, input/output substitute connectors 18 to 33 that control these modules 2 to 17, an instrument panel upper submodule 34 attached to an instrument panel of the vehicle 100, and a multi-driver 35 to drive the instrument panel upper submodule 34.

The front end module 2 includes a plurality of semiconductor relays (hereinafter as SSR) 2A to 2D disposed on a front end of the vehicle 100, and a horn 2E. The front light modules 3, 4 include headlight lamps 3A, 4A (hereinafter as LPs 3A, 4A) disposed respectively on right and left sides of a front portion of the vehicle, motors (hereinafter as MTR) 3B, 4B that drive the LPs 3A, 4A to change optical axes, and SSRs 3C, 4C used to turn on/off power to be supplied to the LPs 3A, 4A and the MTRs 3B, 4B.

The engine compartment module 5 includes a security horn 5A disposed on a front side of the vehicle 100, and the SSR 5B that turn on/off power to be supplied to the security horn 5A.

The front door modules 6, 7 include door switches 6A, 7A disposed respectively at right and left front doors of the vehicle 100 (hereinafter as SWs 6A, 7A), MTRs 6B, 7B that drive the doors to lock and unlock the doors, and SSRs 6C, 7C that turn on/off power to be supplied to the MTRs 6B, 7B. The rear door modules 8, 9 include door switches 8A, 9A disposed respectively at right and left rear doors of the vehicle 100 (hereinafter as SW 8A, 9A), MTRs 8B, 9B that drive the doors to lock and unlock the doors, and SSRs 8C, 9C that turn on/off power to be supplied to the MTRs 8B, 9B.

The instrument panel submodule 10 is formed by including a switch 10A (example of “electronic device”) disposed on the instrument panel of the vehicle 100 (hereinafter as instrument panel), and a switch 11A (hereinafter as SW 11A). Here, the switch 10A is a window defogging switch to defog a rear glass on a rear side of the vehicle 100.

The seat modules 12, 13 include seat switches 12A, 13A (SWs 12A, 13A) disposed respectively at a driver seat and a passenger seat, MTRs 12B, 13B that drive the seats, and SSRs 12C, 13C that turn on/off power to be supplied to the MTRs 12B, 13B. The roof module 14 includes interior lights 14A, 14C disposed at a roof of the vehicle 100 (hereinafter, LPs 14A to 14C).

The rear light modules 15, 16 include rear light lamps 15A, 16A disposed respectively on right and left sides of a rear portion of the vehicle (hereinafter as LPs 15A, 16A), and MTRs 15C, 16C that drive the LPs 15A, 16A to change optical axes. The rear end module 17 includes a plurality of SSRs 17A to 17D disposed at the rear portion of the vehicle 100.

An ECU formed of a computer not illustrated is built in each of the input/output substitute connectors 18 to 33. Further, the input/output substitute connectors 18 to 33 are provided one by one in the respective modules 2 to 17, and perform controlling or monitoring for an electronic device constituting each of the modules 2 to 17.

A radio circuit not illustrated is further built inside the input/output substitute connector 21 connected to the engine compartment module 5, and radio communication with a smart J/B 41 described later can be performed via the multi-driver 35 described later. The engine compartment module 5 and the input/output substitute connector 21 are actuated by receiving power supply different from other modules 2 to 4, 6 to 17 and other input/output substitute connectors 18 to 20, 22 to 33 such that security is not improperly disarmed when a thief breaks into the vehicle or the like and removes an on-vehicle battery, for example.

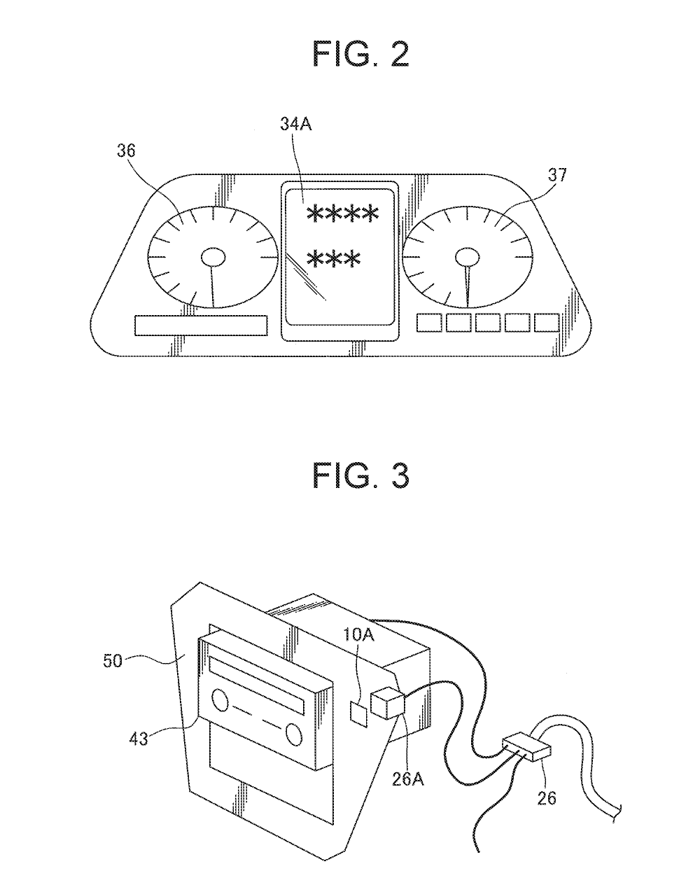

The instrument panel upper submodule 34 is provided at the instrument panel of the vehicle 100, and includes a meter display as a display device (hereinafter as meter DISP) 34A, an ambient unit 34B, a center display (hereinafter as center DISP) 34C, and a head-up display (hereinafter as HUD) 34D. As illustrated in FIG. 2, the meter DISP 34A is disposed between a meter 36 and a meter 37 which display speed and the like of the vehicle 100 and are provided on the instrument panel of the vehicle 100.

Further, the vehicle electrical system 1 further includes: smart junction boxes (hereinafter as smart J/B) 38 to 41 connected to the plurality of input/output substitute connectors 18 to 20, 22 to 33 and each including a distribution circuit in order to distribute power to the plurality of input/output substitute connectors 18 to 20, 22 to 33; and a first wire harness W1 connected to the smart J/Bs 38 to 41 and formed of a power supply line and a communication line (not illustrated).

The smart J/B 38 is connected to the input/output substitute connectors 18 to 20 that control the front end module 2 and the front light modules 3, 4 via the first wire harness W1. More specifically, the input/output substitute connectors 18 to 20 are connectors that connect the first wire harness W1 connected to the smart J/B 38 to a second wire harness W2 connected to the modules 2 to 4.

The smart J/B 38 receives power supply from an on-vehicle battery not illustrated, and supplies the supplied power to the input/output substitute connectors 18 to 20 via the power supply line of the first wire harness W1. The ECUs built in the input/output substitute connectors 18 to 20 are actuated by receiving power supply from the smart J/B 38, and supply power to the respective modules 2 to 4 and further control the same.

An ECU not illustrated and a radio circuit are built in the smart J/B 38, and communication with the input/output substitute connectors 18 to 20 can be performed via the communication line of the first wire harness W1, and further radio communication with the smart J/B 41 described later can be performed via the multi-driver 35. Further, the smart J/B 38 is connected to an engine ECU 42 that controls an engine.

The smart J/B 39 is connected, via the first wire harness W1, to the input/output substitute connectors 22, 24, 28 that control the front door module 6, rear door module 8, and seat module 12 disposed on the right side of the vehicle 100. More specifically, the input/output substitute connectors 22, 24, 28 are connectors that connect the first wire harness W1 connected to the smart J/B 39 to the second wire harness W2 connected to the front door module 6, rear door module 8, and seat module 12.

The smart J/B 39 receives power supply from the smart J/B 41 described later, and supplies this power to the input/output substitute connectors 22, 24, 28 via the power supply line of the first wire harness W1. The ECUs built in the input/output substitute connectors 22, 24, 28 are actuated by receiving power supply from the smart J/B 39, and supply the power to the respective modules 6, 8, and 9 and further control the same.

An ECU not illustrated is built in the smart J/B 39, and communication with the input/output substitute connectors 22, 24, 28 can be performed via the communication line of the first wire harness W1.

The smart J/B 40 is connected to the input/output substitute connectors 31 to 33 that control the rear light modules 15, 16 and the rear end module 17 disposed on the rear side of the vehicle 100 via the first wire harness W1. More specifically, the input/output substitute connectors 31 to 33 are connectors that connect the first wire harness W1 connected to the smart J/B 40 to the second wire harness W2 connected to the modules 15 to 17.

The smart J/B 40 receives power supply from the smart J/B 41 described later, and supplies this power to the input/output substitute connectors 31 to 33 via the power supply line of the first wire harness W1. The ECUs built in the input/output substitute connectors 31 to 33 are actuated by receiving power supply from the smart J/B 40, and supply the power to the respective modules 15 to 17 and further control the same.

An ECU not illustrated is built in the smart J/B 40, and communication with the input/output substitute connectors 31 to 33 can be performed via the communication line of the first wire harness W1.

The smart J/B 41 (example of “junction box”) is connected to the input/output substitute connectors 23, 25, 26, 27, 29, 30 that control: the front door module 7 and the rear door module 9 disposed on the right side of the vehicle 100 via the first wire harness W1; the instrument panel submodules 10 and 11; seat door module 13; and roof module 14. The ECUs built in the input/output substitute connectors 23, 25, 26, 27, 29, 30 are actuated by receiving power supply from the smart J/B 41, and supply the power to the respective modules 7, 9 to 11, 13, 14 and further control the same.

An ECU not illustrated is built in the smart J/B 41, and communication with the input/output substitute connectors 23, 25, 26, 27, 29, 30 and the smart J/Bs 39, 40 can be performed via the communication line of the first wire harness W1. Further, the smart J/B 41 is connected to the multi-driver 35 and functioning as notification unit, and capable of controlling the instrument panel upper submodule 34 via the multi-driver 35 and communicating with the smart J/B 38 and the input/output substitute connector 21 via radio. Further, the smart J/B 41 is directly connected to the electronic devices such as a car audio 43 and SSR 44, and controls the same.

Here, the car audio 43 (example of “electrical component”) is assembled into an opening of the instrument panel in a state of being assembled to a car audio storage interior panel 50 (example of “case”) as illustrated in FIG. 3. This state of the car audio 43 indicates a state in which “the electrical component is mounted on the vehicle” recited in claims. When a thief attempts to remove, for example, the car audio 43 in the state that the car audio 43 is assembled (housed), the car audio storage interior panel 50 is supposed to be removed before the car audio 43.

The above-described window defogging switch 10A is disposed at the car audio storage interior panel 50. The window defogging switch 10A is connected to the input/output substitute connector (example of “connector”) via a window defogging switch connector 26A. The window defogging switch connector 26A is attached to the car audio storage interior panel 50 from an opposite side of a riding space. Therefore, in the case where the car audio storage interior panel 50 is removed from the instrument panel, connection between the window defogging switch 10A and the window defogging switch connector 26A is disconnected.

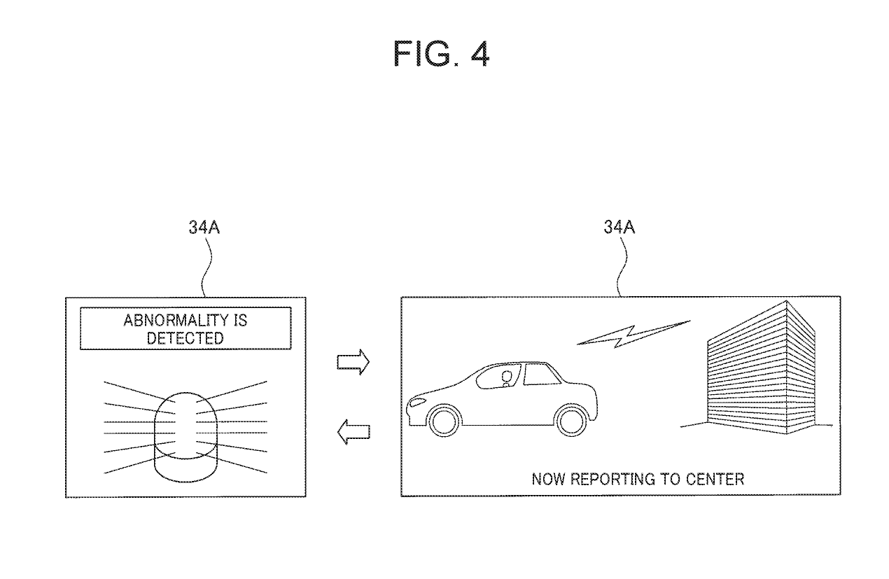

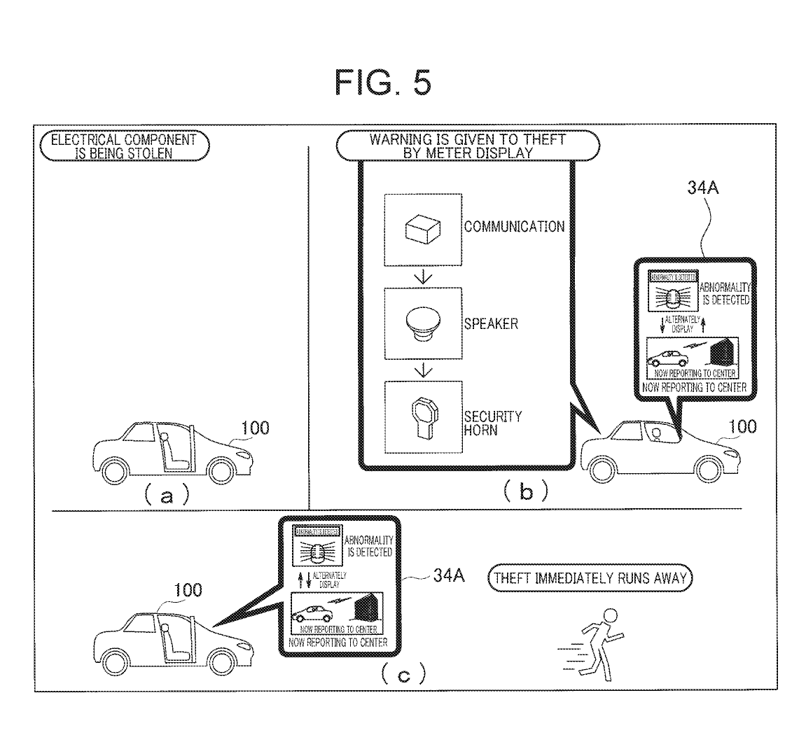

Next, operation of the vehicle electrical system 1 having the above-described configuration will be described with reference to FIGS. 4 and 5. The vehicle electrical system 1 having the above-described configuration is incorporated in the vehicle 100. For example, a thief breaks into the car or the like and removes the car audio storage interior panel 50 from the instrument panel in order to carry away the car audio 43. The window defogging switch connector 26A is detached from the car audio storage interior panel 50. Then, the, connection between the window defogging switch 10A and the window defogging switch connector 26A is disconnected.

The input/output substitute connector 26 acts as theft detection unit, and a detection result by the theft detection unit is transmitted to the communication line of the first wire harness W1 at the time of detecting that connection between the window defogging switch 10A and the window defogging switch connector 26A is disconnected. The detection result transmitted by the input/output substitute connector 26 is transmitted to the smart J/B 41. The smart J/B 41 functions as the notification unit, and when the detection result is received from the input/output substitute connector 26, the smart J/B 41 controls the meter DISP 34A via the multi-driver 35 and displays “abnormality is detected” and “now reporting to the center” alternately on the meter DISP 34A as illustrated in FIG. 4.

According to the above-described vehicle electrical system 1, the input/output substitute connector 26 (theft detection unit) detects that connection of the connected switch 10A (electronic device) is disconnected, the detection result is transmitted to the smart J/B 41, and the smart J/B 41 (notification unit) displays the transmitted detection result on the meter DISP 34A (display device). By this, the fact that connection of the switch 10A (electronic device) is disconnected is detected before the car audio 43 is removed and warning can be given to the thief. Therefore the theft preventing effect for the car audio 43 mounted on the vehicle 100 can be improved.

Meanwhile, according to the above-described embodiment, the description has been given by exemplifying the car audio as the electrical component, and also the description has been given by exemplifying the switch 10A as the electronic device, but the present invention is not limited thereto. The electrical component may be electrical components other than the car audio, and the electronic device may be an electronic device or an electrical part other than the switch 10A. The electronic device is at least required to be attached to a case housing an electrical component and further capable of detecting that connection with the electronic device is disconnected. Further, the description has been given by exemplifying the car audio storage interior panel 50 as the case, but the present invention is not limited thereto. The case is at least required to be removed before an electrical component mounted on the vehicle when an attempt is made to remove the electrical component. Further, the ECUs are built in the input/output substitute connectors 18 to 33, but the present invention is not limited thereto. The ECU may be provided at a place different from the input/output substitute connector.

Additionally, according to the above-described embodiment, a notification is given by displaying “now reporting to the center” and the like on the meter DISP 34A to warn the thief, but the present invention is not limited thereto. For example, the notification may be given by a sound or an alarm by using a speaker or a security horn 5A. Alternatively, report may be made to the outside by using a wireless device, for example. Also, the notification may be displayed on a different display device mounted on the vehicle.

Further, the above-described embodiment is recited merely as a typical embodiment of the present invention, and the present invention is not limited thereto. In other words, various kinds of modifications can be made in a range without departing from the scope of the present invention.

### REFERENCE SIGNS LIST

1 Vehicle electrical system (theft protection system)
10A Switch (electronic device)
26 Input/output substitute connector (connector, theft detection unit)
34A Meter DISP (display device)
41 Smart J/B (notification unit, junction box)
43 Car Audio (electrical component)
100 Vehicle

1. A theft protection system for an electrical component mounted on a vehicle, comprising:
an electronic device attached to a case housing the electrical component;
a theft detection unit configured to detect that connection of the electronic device is disconnected;
a notification unit configured to notify a detection result by the theft detection unit; and
a wireless device mounted on the vehicle is further provided,
wherein the notification means is at least configured to report to an outside by using the wireless device.

2. The theft protection system according to claim 1, further comprising a display device mounted on the vehicle, wherein the notification unit is configured so as to displays a detection result by the theft detection unit on the display device.

3. The theft protection system according to claim 1, further comprising
a junction box configured to distribute power, and
a connector configured to connect the junction box to the electronic device,
wherein the theft detection unit is disposed at the connector, and the notification unit is disposed at the junction box.

4. The theft protection system according to claim 2, further comprising
a junction box configured to distribute power, and
a connector configured to connect the junction box to the electronic device,
wherein the theft detection unit is disposed at the connector, and the notification unit is disposed at the junction box.
